(19) United States
(12) Patent Application Publication
(10) Pub. No.: US 2010/0108932 A1
(43) Pub. Date: May 6, 2010

(54) BEARING ASSEMBLY AND A METHOD FOR CONTROLLING FLUID FLOW WITHIN A CONDUIT

(76) Inventors: Robert R. Bauer, Rockford, IL (US); James R. Downs, Rockton, IL (US); Gerhardt A. Banjac, Bryon, IL (US); David R. Shenk, South Beloit, IL (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/263,051

(22) Filed: Oct. 31, 2008

(51) Int. Cl. F16K 1/22; F16C 33/58; B64D 15/00

(52) U.S. Cl. 251/305; 137/899.2; 384/571; 137/1

(57) ABSTRACT

A valve system includes a conduit having a flow of fluid therethrough, and a butterfly valve assembly. The butterfly valve assembly includes a shaft extending obliquely within the conduit, a butterfly disk, and a first bearing assembly positioned on an external surface of the conduit. The butterfly disk includes a passage sized to receive the shaft therethrough, wherein the butterfly disk is operable to restrict the fluid flow through the conduit when the butterfly valve assembly is in the closed position. The first bearing assembly is configured to receive a first end of the shaft therethough, wherein the first bearing assembly includes a plurality of tapered roller bearings circumferentially-spaced within a bearing race and configured to maintain the butterfly disk at a substantially constant axial position when the butterfly valve assembly is in the closed position.

### BACKGROUND OF THE INVENTION

The field of the disclosure relates generally to valve assemblies, more particularly to tapered roller bearings used in butterfly valve shaft housings.

Butterfly valves are one of many types of valves that are used to control the flow of fluids within a conduit. More specifically, some known butterfly valves include a disc (also known as a “butterfly”) that is rotated within a fluid flow conduit for use in controlling fluid flowing therethrough in varying amounts. In such known systems, the disc includes two shafts that extend radially outward from the disk and that are coupled substantially circumferentially opposite one another. Each shaft is received within a shaft housing such that the disk may rotate on an axis that traverses the conduit between an open position and a closed position. When the disc is in the open position, the plane of the disc is substantially coincident or parallel to the direction of flow such that the fluid flow rate may be maximized therethrough. When the disc is in the closed position, the plane of the disc is substantially transverse/orthogonal to the direction of flow such that the fluid flow rate may be minimized or completely blocked.

Some known butterfly valve assemblies include a bearing assembly positioned within the shaft housing that receives each shaft therethrough and provides for a substantially smooth rotation of the disk between the open and closed position. In such assemblies, the bearing assembly includes a plurality of spherical bearings positioned within a bearing race that facilitates reducing friction as the shift rotates within the housing.

Some known discs may be alternatively mounted obliquely within the conduit such that one shaft housing is positioned upstream of the other such that the plane of the disc may be offset at an angle with respect to the direction of flow. When encountering a flow when placed in the closed position, the disk experiences a load that is translated as an axial force acting along the rearwardly located shaft. However, the disk in such systems should not experience any noticeable axial displacement as it must return to same position each time it returns to the closed position. Known systems that use round roller bearings within the bearing assemblies experience an axial displacement of the disk and therefore lack an axial position control suitable for systems that use an obliquely mounted butterfly valve disk.

### BRIEF DESCRIPTION OF THE INVENTION

In one aspect, a valve system is provided. The valve system includes a conduit having a flow of fluid therethrough, and a butterfly valve assembly. The butterfly valve assembly includes a shaft extending obliquely within the conduit, a butterfly disk, and a first bearing assembly positioned on an external surface of the conduit. The butterfly disk includes a passage sized to receive the shaft therethrough, wherein the butterfly disk is operable to restrict the fluid flow through the conduit when the butterfly valve assembly is in the closed position. The first bearing assembly is configured to receive a first end of the shaft therethough, wherein the first bearing assembly includes a plurality of tapered roller bearings circumferentially-spaced within a bearing race and configured to maintain the butterfly disk at a substantially constant axial position when the butterfly valve assembly is in the closed position.

In another aspect, a bearing assembly is provided. The bearing assembly is configured to receive a first end of a shaft therethough, wherein the first bearing assembly includes a plurality of tapered roller bearings circumferentially-spaced within a bearing race and configured to maintain a butterfly valve assembly at a substantially constant axial position when the butterfly valve assembly is in the closed position.

In yet another aspect, a method for controlling a flow of fluid within a conduit is provided. The method includes positioning a butterfly valve assembly within the conduit such that a shaft extends obliquely within the conduit, wherein the butterfly valve assembly includes a butterfly disk operable between an open and closed position. The method also includes maintaining a butterfly disk at a substantially constant axial position using a plurality of tapered roller bearings circumferentially spaced within at least one bearing assembly positioned on an external surface of the conduit.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a schematic illustration of an exemplary anti-ice system used in an exemplary aircraft.

FIG. 2 is a sectional view of an exemplary valve system used with the exemplary anti-ice system shown in FIG. 1.

FIG. 3 is a perspective view of an exemplary bearing assembly used with the exemplary valve system shown in FIG. 2.

FIG. 4 a sectional view of the exemplary bearing assembly.

FIG. 5 is an end view of an exemplary bearing race used with bearing assembly shown in FIG. 3.

FIG. 6 is a sectional view along line 6-6 shown in FIG. 5 of an exemplary bearing race used with bearing assembly shown in FIG. 3.

FIG. 7 is an end view of an exemplary tapered roller bearing used with bearing assembly shown in FIG. 3.

FIG. 8 is a sectional view along line 8-8 shown in FIG. 7 of an exemplary tapered roller bearing used with bearing assembly shown in FIG. 3.

FIG. 9 is an end view of an exemplary bearing cage used with bearing assembly shown in FIG. 3.

FIG. 10 is a sectional view along line 10-10 shown in FIG. 9 of an exemplary bearing cage used with bearing assembly shown in FIG. 3.

FIG. 11 is an end view of an exemplary outer bearing ring used with bearing assembly shown in FIG. 3.

FIG. 12 is a sectional view along line 12-12 shown in FIG. 11 of an exemplary outer bearing ring used with bearing assembly shown in FIG. 3.

FIG. 13 is a flow diagram for method of controlling a flow of fluid within a conduit.

### DETAILED DESCRIPTION OF THE INVENTION

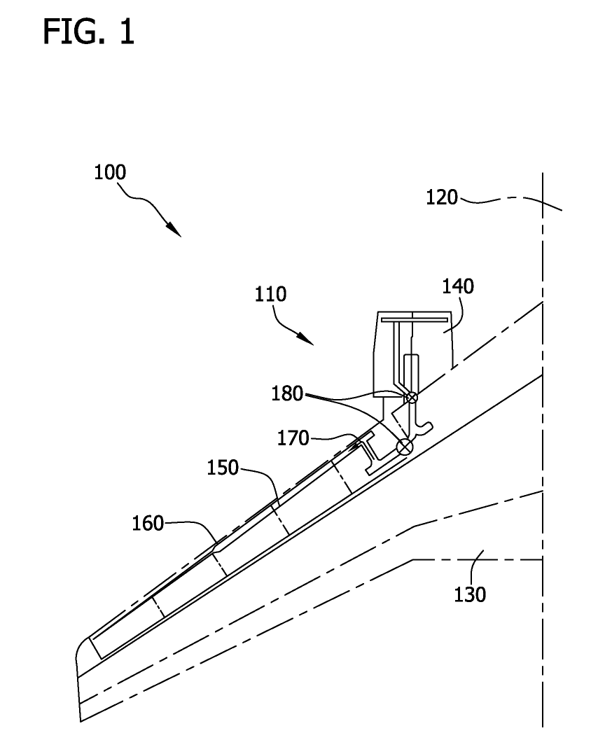

FIG. 1 is a schematic illustration of an exemplary aircraft 100 that includes in an exemplary anti-ice system 110. In the exemplary embodiment, an aircraft 100 includes a fuselage 120 and a wing 130 extending therefrom, and includes a gas turbine engine 140 coupled to wing 130. Anti-ice system 110 includes a conduit 150 that extends from engine 140 along a leading edge 160 of wing 130 that is sized and oriented to channel a flow of high temperature bleed air 170 from engine 140 along leading edge 160 to substantially prevent accumulation of ice on wing 130 during cold weather conditions and/or while in flight. Anti-ice system 110 includes a valve assembly 180 that regulates the flow of bleed air 170 from engine 140 along leading edge 160. Alternatively, valve assembly 180 may be positioned within any aircraft system and along any conduit within aircraft, or any other vehicle, that requires pressure regulating and control of a fluid therethrough.

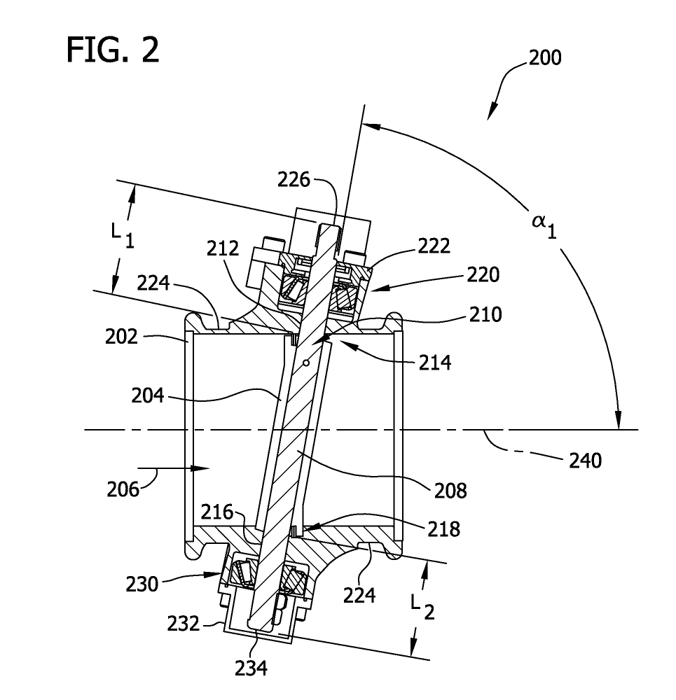

FIG. 2 is a sectional view of an exemplary valve system 200 used with anti-ice system 110 shown in FIG. 1. In the exemplary embodiment, valve system 200 is positioned within conduit 202, as described in more detail herein. Valve system 200 includes a butterfly disk 204 positioned within conduit 202 and sized to substantially minimize a fluid flow, indicated by arrow 206, through conduit 202 when butterfly disk 204 is in a closed position, as shown in FIG. 2. A shaft 208 extends through a passage 210 defined within butterfly disk 204 that is sized and oriented to rotate butterfly disk 204 between an open and the closed position. More specifically, and in the exemplary embodiment, shaft 208 extends a length L₁ through a bore 212 in conduit 202 at a first location 214, and similarly extends a length L₂ through a bore 216 in conduit 202 and at a radially opposite second location 218. In the exemplary embodiment, a first bearing assembly 220 is positioned within a corresponding bearing cover 222 on an external surface 224 of conduit 202 and is sized and oriented to receive a first end 226, and length L₁, of shaft 208 therein. Similarly, a second bearing assembly 230 is positioned in a corresponding bearing cover 232 on external surface 224 of conduit 202 and is sized and oriented to receive an opposite second end 234, and length L₂, of shaft 208 therein. During operation, bearing assemblies 220, 230 provide for a substantially frictionless rotation of butterfly disk 204 when butterfly disk 204 is rotated between the open and closed position, as described in more detail herein.

As illustrated in FIG. 2, shaft 208 extends through conduit 202 at an angle α₁ measured from a central axis 240. In the exemplary embodiment, angle α₁ is approximately 80°. Alternatively, angle α₁ may be an angle ranging from about 75° to about 85°, or any angle that enables valve assembly 200 to function as described herein.

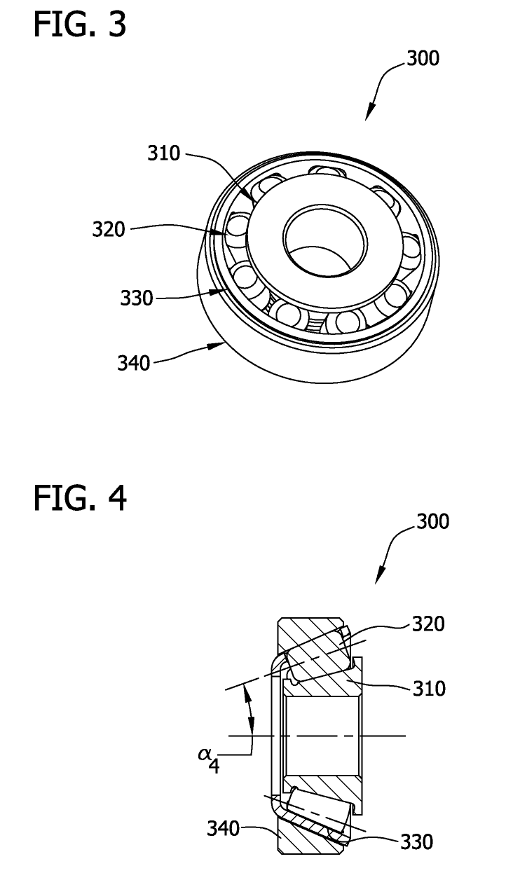

FIG. 3 is a perspective view, and FIG. 4 is a sectional view, of an exemplary bearing assembly 300, such as for example first bearing assembly 220 and/or second bearing assembly 230, used with valve system 200 shown in FIG. 2. In the exemplary embodiment, bearing assembly 300 includes a inner bearing race 310, a plurality of tapered roller bearings 320 positioned within bearing race 310, a bearing cage 330 that receives and maintains each of the plurality of roller bearings 320 in a circumferential position around inner bearing race 310, as described herein. Bearing assembly includes an outer bearing ring 340 that receives inner bearing race 310, tapered roller bearings 320 and cage 330 therein, as described in more detail herein.

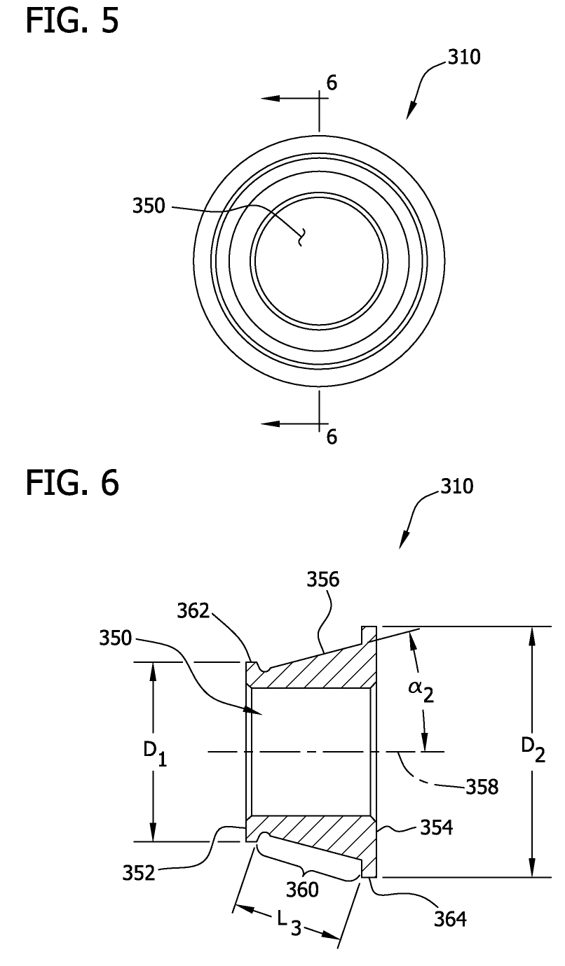

FIG. 5 is an end view, and FIG. 6 is a sectional view of an exemplary bearing race 310 used with bearing assembly 300 shown in FIG. 3. In the exemplary embodiment, bearing race 310 is substantially cylindrical in cross-section and includes an aperture 350 that is sized and oriented to receive shaft 208 therethrough, as shown in FIG. 2. In the exemplary embodiment, bearing race 310 includes a diameter D₁ at a first end 352 and a diameter D₂ at a second end 354, wherein D₂ is greater than D₁ such that an obliquely oriented surface 356 extends between first end 352 and second end 354. Oblique surface 356 is offset from an axis of rotation 358 at an angle α₂. In the exemplary embodiment, angle α₂ is approximately 15°. Alternatively, bearing race 310 is sized and oriented to enable bearing assembly 300 to function as described herein.

In the exemplary embodiment, bearing race 310 includes a channel 360 that extends a length L₃ over oblique surface 356. Channel 360 is sized and oriented to receive tapered roller bearings 320 therein, as described in more detail herein, and as shown for example in FIG. 3. Bearing race 310 includes a first flange 362 positioned adjacent to bearing race first end 352 that maintains tapered roller bearing 320 within channel 360. Similarly, bearing race 310 includes a second flange 364 positioned adjacent to bearing race second end 354 that further maintain tapered roller bearing 320 within channel 360. Alternatively, bearing race 310 may include any lip, extension or retention element that will substantially maintain tapered roller bearings 320 within channel 360 and that will enable bearing assembly 300 to function as described herein.

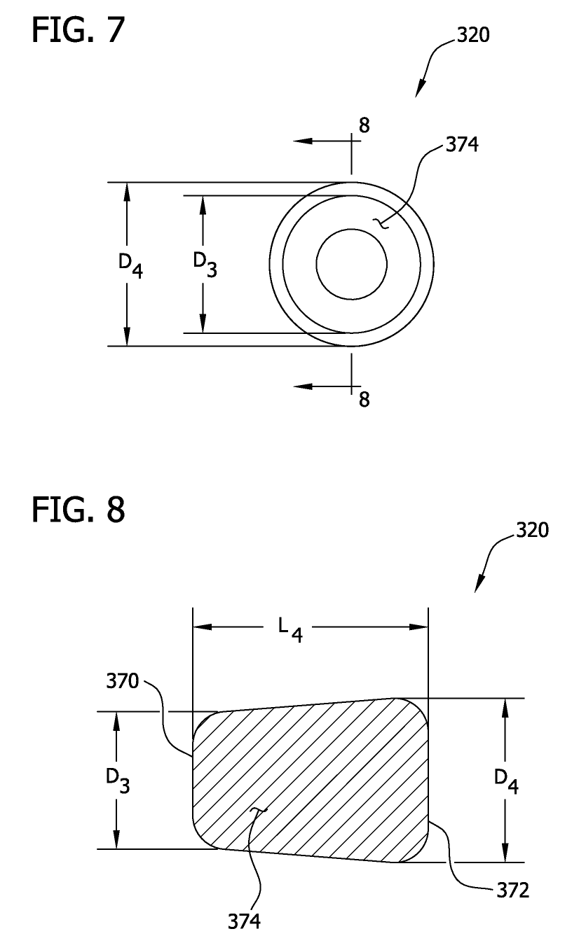

FIG. 7 is an end view and FIG. 8 is a sectional view of an exemplary tapered roller bearing 320 used with bearing assembly 300 shown in FIG. 3. In the exemplary embodiment, tapered roller bearing 320 is substantially conical in cross-section. More specifically, tapered roller bearing 320 includes a first end 370 having a diameter D₃ and a second end 372 having a diameter D₄, wherein, in the exemplary embodiment, D₄ is greater than D₃. Tapered roller bearing 320 includes an outer surface 374 that is substantially smooth in contour and that includes a length L₄ such that tapered roller bearing 320 fits within bearing race channel 360, as shown in FIG. 6.

In the exemplary embodiment, tapered roller bearing 320 is fabricated from a heat treated 440C stainless steel that is machined using a turning process. Alternatively, tapered roller bearing may be fabricated from any corrosion resistant material that may be used in temperatures of up to approximately 650° F.

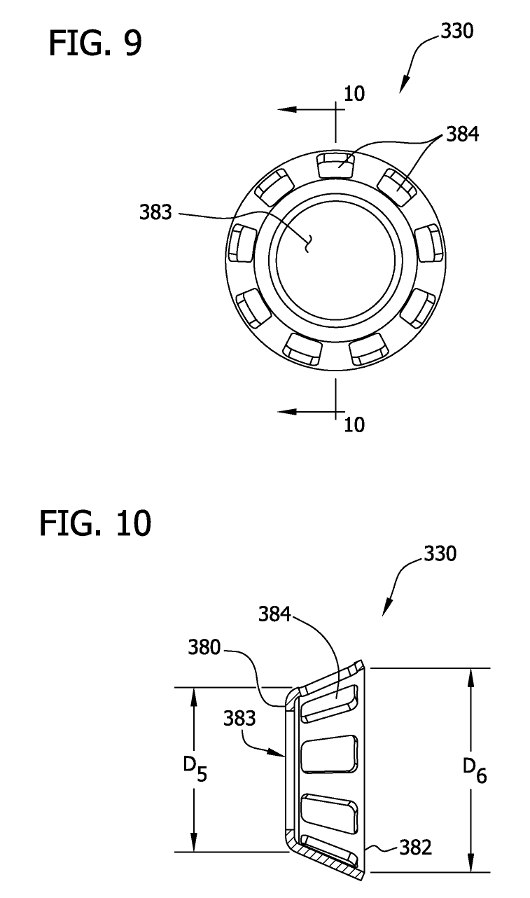

FIG. 9 is an end view and FIG. 10 is a sectional view of an exemplary bearing cage 330 used with bearing assembly 300 shown in FIG. 3. In the exemplary embodiment, bearing cage 330 is substantially conical in cross-section. More specifically, bearing cage 330 includes a first end 380 having a diameter D₅ and a second end 382 having a diameter D₆, wherein, in the exemplary embodiment, D₆ is greater than D₅. In the exemplary embodiment, bearing cage 330 includes an aperture 383 that is sized and oriented to receive bearing race 310 (shown in FIG. 3) therethrough. In the exemplary embodiment, bearing cage 330 includes a plurality of circumferentially-spaced receptacles 384 that are sized and oriented to receive a corresponding number of tapered roller bearings 320 therein, as shown in FIG. 3. Moreover, bearing cage 330 is sized such that diameter D₅ is greater than bearing race diameter D₁, and such that bearing cage 330 will receive bearing race 310 and tapered roller bearings 320 therein when tapered roller bearings 320 are positioned within channel 360.

In the exemplary embodiment, bearing cage 330 is fabricated from an aluminum/bronze alloy using a machining process. Alternatively, bearing cage may be fabricated from any corrosion resistant material that may be used in temperatures of up to approximately 650° F.

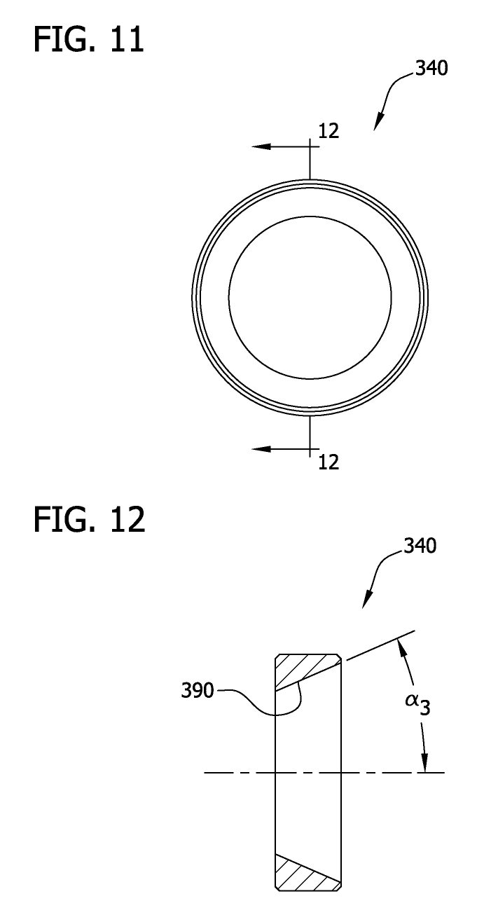

FIG. 11 is an end view and FIG. 12 is a sectional view of an exemplary outer bearing ring 340 used with bearing assembly 300 shown in FIG. 3. In the exemplary embodiment, outer bearing ring 340 is substantially circular and is sized and configured to receive bearing race 310, tapered roller bearings 320 and bearing cage 330 therein. More specifically and in the exemplary embodiment, outer bearing ring 340 includes an inner track surface 390 that is sized and oriented to receive tapered roller bearings 320 when tapered roller bearings 320 are positioned within corresponding channel 360 and receptacles 384, shown in FIGS. 3 and 4. Inner track surface 390 includes an angle α₃ that is substantially equivalent to an angle α₄ (shown in FIG. 4) defined by tapered roller bearings 320 when positioned within corresponding channel 360 and receptacle 384.

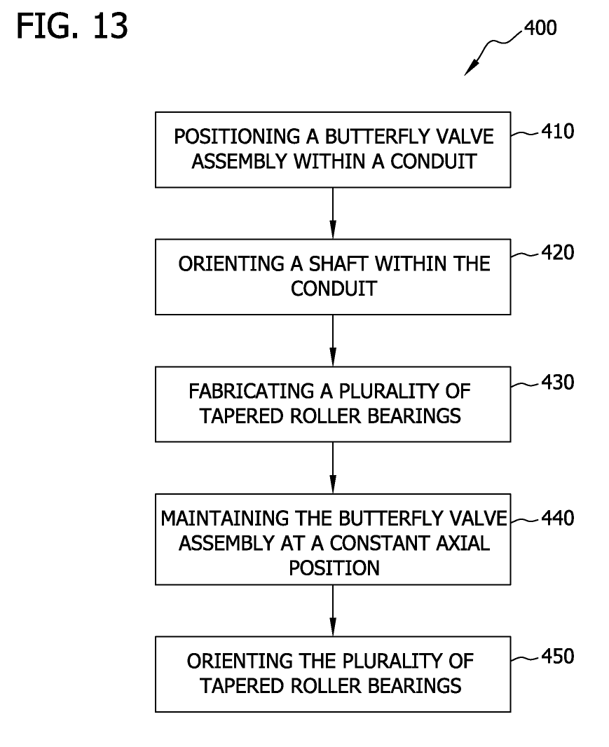

FIG. 13 is a flow diagram for method 400 of controlling a flow of fluid within a conduit, such as for example conduit 150 shown in FIG. 1. In the exemplary embodiment, method 400 includes positioning 410 a butterfly valve assembly within the conduit such that a shaft extends obliquely within the conduit, as described herein. The butterfly valve assembly includes a butterfly disk operable between an open and closed position. Positioning 410 the butterfly valve assembly within the conduit further includes orienting 420 the shaft within the conduit at an angle offset from an axis of flow at approximately 10 degrees.

In the exemplary embodiment, method 400 includes fabricating 430 a plurality of tapered roller bearings using a machining process, such as for example a turning process using a lathe, or alternatively, a stamping process. Method 400 includes maintaining 440 the butterfly disk at a substantially constant axial position using a plurality of tapered roller bearings circumferentially spaced within at least one bearing assembly positioned on an external surface of the conduit. Maintaining 440 the butterfly disk at a substantially constant axial position further includes orienting 450 the plurality of tapered roller bearings at a bearing angle of approximately 20 degrees.

Exemplary embodiments of bearing assemblies and valve systems are described in detail above. The above-described bearing assemblies facilitate maintaining an axial and radial position for components of the valve system during operation by including tapered roller bearings within a bearing race and housing. Furthermore, the tapered roller bearing described herein are fabricated from a tempered, stainless steel material that will withstand high temperatures and that will substantially prevent corrosion, and therefore may be used in a broader range of applications.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

Although the apparatus and methods described herein are described in the context of bearing assemblies for use with anti-ice systems on aircraft, it is understood that the apparatus and methods are not limited to aerospace applications. Likewise, the system components illustrated are not limited to the specific embodiments described herein, but rather, system components can be utilized independently and separately from other components described herein.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A valve system comprising:
a conduit including a flow of fluid therethrough; and
a butterfly valve assembly comprising;
a shaft extending obliquely within the conduit;
a butterfly disk comprising a passage sized to receive said shaft therethrough, said butterfly disk operable to restrict the fluid flow through the conduit when said butterfly valve assembly is in a closed position; and
a first bearing assembly positioned on an external surface of said conduit and configured to receive a first end of said shaft therethough, said first bearing assembly comprising a plurality of tapered roller bearings circumferentially spaced along a bearing race and configured to maintain said butterfly disk at a substantially constant axial position when said butterfly valve assembly is in the closed position.

2. A valve system in accordance with claim 1, further comprising a second bearing assembly positioned radially-opposite of said first bearing assembly on the external surface of said conduit, said second bearing assembly configured to receive a second end of said shaft therethough, said second bearing assembly comprising a plurality of tapered roller bearings circumferentially spaced along a bearing race and configured to maintain said butterfly disk at a substantially constant axial position when said butterfly valve assembly is in the closed position.

3. A valve system in accordance with claim 2, wherein said first bearing assembly comprises a first bearing cage comprising a first plurality of receptacles configured to receive said first plurality of tapered roller bearings therein, and wherein said second bearing assembly comprises a second bearing cage comprising a second plurality of receptacles configured to receive said second plurality of tapered roller bearings therein.

4. A valve system in accordance with claim 2, wherein said first bearing assembly comprises an inner bearing ring comprising an inner bore configured to receive said first end of said shaft therein.

5. A valve system in accordance with claim 2, wherein said first and second plurality of tapered roller bearings are positioned within respect to said first and second bearing races at a bearing angle of approximately 20 degrees.

6. A valve system in accordance with claim 2, wherein said first and second plurality of tapered roller bearings are fabricated from stainless steel.

7. A valve system in accordance with claim 1, wherein said butterfly valve assembly is positioned within an aircraft anti-ice system.

8. A valve system in accordance with claim 1, wherein said shaft is positioned within said conduit at an angle offset approximately 10 degrees from verical.

9. A bearing assembly for a butterfly valve, said bearing assembly comprising a first bearing assembly positioned on an external surface of a conduit and configured to receive a first end of a shaft therethough, said first bearing assembly comprising a plurality of tapered roller bearings circumferentially spaced within a bearing race and configured to maintain a butterfly valve assembly at a substantially constant axial position when the butterfly valve assembly is in a closed position.

10. A bearing assembly in accordance with claim 9, further comprising a second bearing assembly positioned radially-opposite of said first bearing assembly on the external surface of said conduit, said second bearing assembly configured to receive a second end of said shaft therethough, said second bearing assembly comprising a plurality of tapered roller bearings circumferentially spaced within a bearing race and configured to maintain said butterfly disk at a substantially constant axial position when said butterfly valve assembly is in the closed position.

11. A bearing assembly in accordance with claim 10, wherein said first bearing assembly comprises a first bearing cage comprising a first plurality of receptacles configured to receive said first plurality of tapered roller bearings therein, and wherein said second bearing assembly comprises a second bearing cage comprising a second plurality of receptacles configured to receive said second plurality of tapered roller bearings therein.

12. A bearing assembly in accordance with claim 10, wherein said first bearing assembly comprises an inner bearing ring comprising an inner bore configured to receive said first end of said shaft therein.

13. A bearing assembly in accordance with claim 10, wherein said first and second plurality of tapered roller bearings are positioned within respect to said first and second bearing races at a bearing angle of approximately 20 degrees.

14. A bearing assembly in accordance with claim 10, wherein said first and second plurality of tapered roller bearings are fabricated from stainless steel.

15. A bearing assembly in accordance with claim 9, wherein said butterfly valve assembly is positioned within an aircraft anti-ice system.

16. A bearing assembly in accordance with claim 9, wherein said shaft is positioned within said conduit at an angle offset approximately 10 degrees from vertical.

17. A method for controlling a flow of fluid within a conduit, said method comprising:
positioning a butterfly valve assembly within the conduit such that a shaft extends obliquely within the conduit, wherein the butterfly valve assembly includes a butterfly disk operable between an open and closed position; and
maintaining a butterfly disk at a substantially constant axial position using a plurality of tapered roller bearings circumferentially spaced within at least one bearing assembly positioned on an external surface of the conduit.

18. A method in accordance with claim 17, wherein positioning a butterfly valve assembly within the conduit further comprises positioning the shaft within the conduit at an angle offset approximately 10 degrees from vertical.

19. A method in accordance with claim 17, wherein maintaining said butterfly disk at a substantially constant axial position further comprises orienting the plurality of tapered roller bearings at a bearing angle of approximately 20 degrees.

20. A method in accordance with claim 17, further comprising fabricating a plurality of tapered roller bearings using a machining process.
